(19) United States
(12) Patent Application Publication
(10) Pub. No.: US 2007/0239845 A1
(43) Pub. Date: Oct. 11, 2007

(54) IMAGE PROCESSING APPARATUS, METHOD THEREFOR, AND IMAGE PROCESSING SYSTEM

(75) Inventor: Yoshiko Sueshige, Meguro-ku (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/697,214

(22) Filed: Apr. 5, 2007

(30) Foreign Application Priority Data
Apr. 10, 2006 (JP) 2006-108029

(51) Int. Cl. G06F 15/16

(52) U.S. Cl. 709/217

(57) ABSTRACT

When the destination computer for receiving image data is specified, a command for activating a screen saver in the destination computer is transmitted through a network. After the screen saver is activated in the destination computer, image data is transmitted to the destination computer through the network.

### BACKGROUND OF THE INVENTION

1. Field of the Invention

The present invention relates to an image processing apparatus which outputs image data to an external device, a control method therefor, and an image processing system including the image processing apparatus.

2. Description of the Related Art

Recently, with the rapid proliferation of personal computers (PCs), an increasing number of users use devices such as digital cameras and image scanners while connecting them to personal computers. As image forming apparatuses such as copying machines, multi function peripheral equipment (MFPs) have appeared on the market, which additionally include the printer function of printing outputs from a PC, the scanner function of reading an original on the original table and inputting the read data to the PC. These apparatuses have remarkably grown in demand. Furthermore, image forming systems that can print and scan images by using these MFPs through networks have become popular. A network system to which a plurality of PCs can connect allows transfer of image data read by an MFP, which a plurality of users share, to a designated PC on a network.

In such a system, an MFP and each PC are often placed in separate places to allow a plurality of users to share the MFP through a network. For this reason, when an operator scans and reads a confidential original or an original which he/she does not want others to see by using the MFP by himself/herself and transfers the read image data to the PC belonging to the operator himself/herself, the image data may be transferred to the PC in the absence of the operator. In addition, the image data transmitted in this manner is transferred to an application set in the PC. Some applications display the image on the display unit of the PC immediately when receiving the image data, although it depends on the specifications of the application. Consequently, in the absence of the operator, any person other than the operator of the PC can browse or access the image data.

As described above, when a given user handles a confidential original or an original which he/she does not want others to view while a plurality of users share an MFP, it is especially important to consider the problem of security protection. In order to solve these problems, Japanese Patent Laid-Open No. 2004-186810 discloses a technique of providing a data security mode for a transmission-side apparatus which transmits image data and a reception-side apparatus and performing security processing based on the security mode. In addition, Japanese Patent Laid-Open No. 2005-079681 discloses a technique of allowing the operator to select whether to encrypt and transfer a read image upon completion of an original reading operation.

According to Japanese Patent Laid-Open No. 2004-186810, however, since it is necessary to set the data security mode on the transmitting apparatus side and the receiving apparatus side of image data, such an operation is cumbersome for a general user. The technique disclosed in Japanese Patent Laid-Open No. 2005-079681 can improve the accuracy of security protection with respect to image data to be transferred by encrypting the read image data. In addition, allowing the operator to select whether encryption is necessary will increase the versatility of this technique. However, the technique complicates the arrangement of each apparatus, leading to deterioration in operability.

### SUMMARY OF THE INVENTION

The present invention provides an image output apparatus which can safely and easily output image data to an external device, a method therefor, and an image processing system.

According to an aspect of the present invention, there is provided an image processing apparatus which communicates with an external destination device through a network. The image processing apparatus includes: a transmitting unit configured to transmit a command for activating a screen saver in the external destination device through the network when the external destination device is specified to receive image data; and a control unit configured to control the transmitting unit to transmit the image data to the external destination device through the network after activating the screen saver in the external destination device.

There is also provided an image processing system including an image processing apparatus and a computer device which connect to each other through a network. The image processing apparatus includes: a transmitting unit configured to transmit a command for activating a screen saver in the destination computer device through the network when the destination computer device is specified for receiving image data; and a control unit configured to control the transmitting unit to transmit the image data to the destination computer device through the network after activating the screen saver in the destination computer device. The destination computer device includes: a display unit configured to display the screen saver in response to reception of the command for activating the screen saver; and a receiving unit configured to receive the image data transmitted from the image processing apparatus after activation of the screen saver.

There is also provided a method of an image processing apparatus which includes a communication unit configured to communicate with an external device through a network and causes the communication unit to transmit image data to the external device. The method includes: causing the communication unit to transmit a command for activating a screen saver in the destination device through the network when a destination device for receiving image data is specified; and causing the communication unit to transmit the image data to the destination device after the screen saver is activated in the destination device.

The present invention can safely output image data to an external device while preventing others from seeing the data.

Further features of the present invention will become apparent from the following description of exemplary embodiments (with reference to the attached drawings).

### BRIEF DESCRIPTION OF THE DRAWINGS

FIG. 1 is a block diagram showing the arrangement of a system according to an embodiment of the present invention;

FIG. 2 is a block diagram showing the arrangement of an MFP according to this embodiment and an example of the arrangement of a system including the MFP;

FIG. 3 is a flowchart illustrating processing in the MFP according to the first embodiment of the present invention;

FIG. 4 is a flowchart illustrating processing in a host computer according to the first and third embodiments of the present invention;

FIG. 5 is a flowchart illustrating processing in an MFP according to the second embodiment of the present invention;

FIG. 6 is a flowchart illustrating processing in an MFP according to the third embodiment of the present invention; and

FIG. 7 is a sequence chart illustrating the exchange of information between an MFP and a host computer in a system according to this embodiment.

### DESCRIPTION OF THE EMBODIMENTS

Exemplary embodiments of the present invention will be described in detail with reference to the accompanying drawings. Note that the following embodiments do not limit the scope of the claims of the present invention, and not all the combinations of features described in the embodiments are essential to solve the problems in the present invention. Note that the screen saver in this embodiment is software generally designed to blacken the screen or display simple animation on the screen when the user is not using the computer or leaves it and it can be cancelled when the user operates the keyboard or mouse (pointing device).

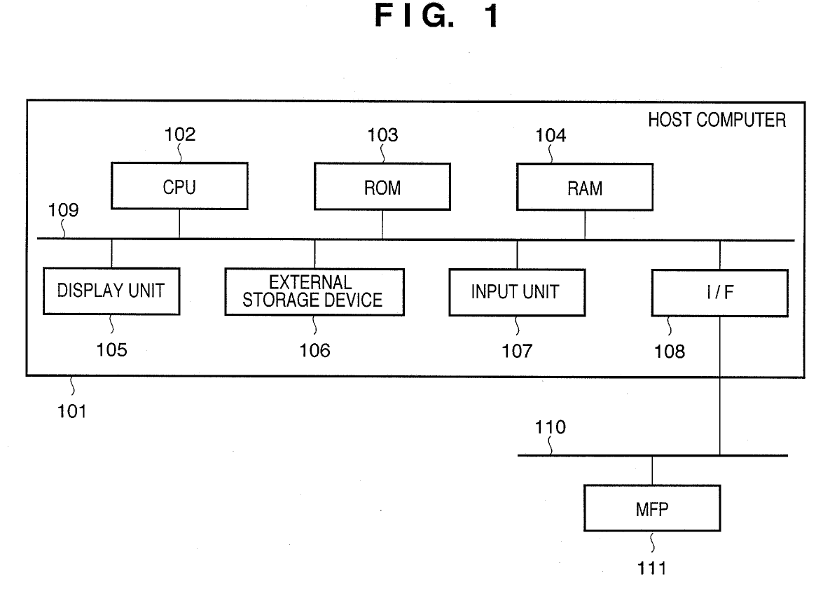

FIG. 1 is a block diagram showing the arrangement of the system according to an exemplary embodiment of the present invention.

A host computer 101 connects to peripheral devices such as an MFP 111 through a communication bus 110 such as Ethernet or USB. The MFP 111 has a PC printer function of receiving and printing print data from a PC such as a host computer in addition to a copying machine function, facsimile function, scanner function, and the like.

The internal arrangement of the host computer 101 will be described next. A CPU 102 controls the overall operation of this apparatus in accordance with the program loaded in a ROM 103 and RAM 104. When the apparatus is activated, the CPU 102 loads the operating system stored in the ROM 103 or an external storage device 106 into the RAM 104, and controls the computer by executing the program. A display unit 105 is a CRT or a liquid crystal display, which can display various kinds of information under the control of the CPU 102. An input unit 107 includes a keyboard, a pointing device (mouse), and the like, and input various kinds of data to the CPU 102. An internal bus 109 in the host computer allows exchange of data between the CPU 102, the ROM 103, the RAM 104, the display unit 105, the external storage device 106, the input unit 107, an external I/F 108, and the like. The external storage device 106 is, for example, a large-capacity storage device such as a hard disk, in which various kinds of applications, an OS, and the like are installed and stored from a storage medium such as a CD-ROM.

The MFP (Multi Function Peripheral Equipment) 111 corresponds to an image processing apparatus according to this embodiment. This image processing apparatus is not limited to the MFP 111 and may be an apparatus which performs image formation, image display, or output operations such as image data transfer with respect to image data on an original read by a scanner, image data read out from a storage medium, or image data received from a website. More specifically, a PC, scanner apparatus, copying machine, facsimile apparatus, or the like corresponds to this image processing apparatus.

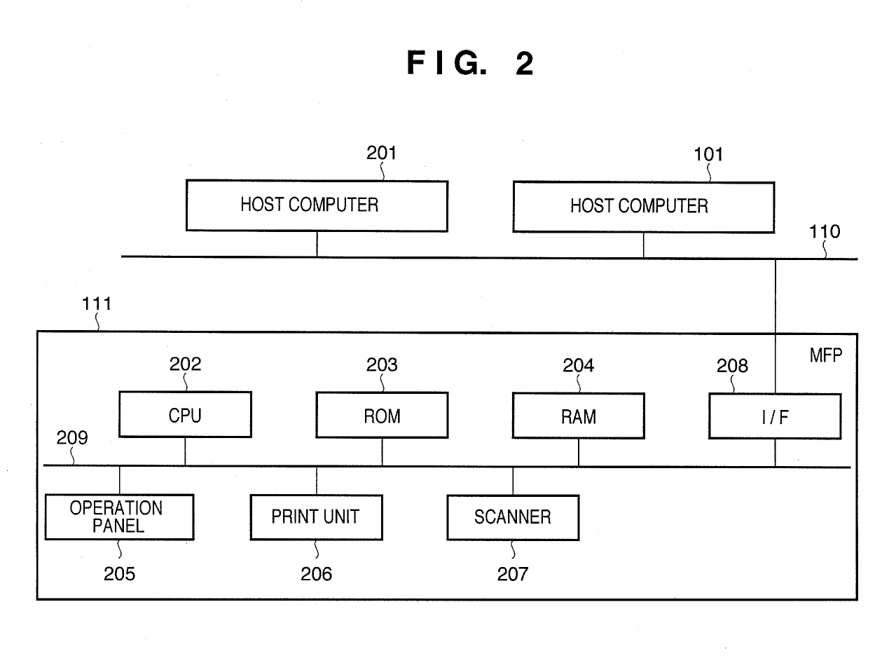

FIG. 2 is a block diagram showing the arrangement of the MFP 111 according to this embodiment and an example of the arrangement of a system including the MFP 111.

The MFP 111 includes a CPU 202, ROM 203, RAM 204, operation panel 205, print unit 206, scanner 207, external I/F 208, and internal bus 209. The external I/F 208 connects to the host computers 101 and 201 through the communication bus 110 such as Ethernet or USB. FIG. 2 shows only the two host computers. However, the external I/F 208 can connect an arbitrary number of host computers through the communication bus 110.

The CPU 202 controls the operation of the MFP 111 and performs arithmetic processing in accordance with control programs stored in the ROM 203. The ROM 203 stores the control programs executed by the CPU 202 and various data. The RAM 204 includes a memory, a hard disk, or the like. The RAM 204 has an area for storing image data read by the scanner 207, an area for storing set values for various kinds of operations and setting information including the transfer destination address of image data, an area for storing authentication data for authenticating the user of the MFP 111, and the like. The operation panel 205 includes an operation unit for issuing an operation instruction with respect to the MFP 111, and a display unit for displaying various kinds of information for the operator. The print unit (print engine) 206 prints on a paper sheet based on a print job. The scanner 207 includes an image sensor, reads an original by scanning it using the image sensor, and outputs the data as image data.

### First Embodiment

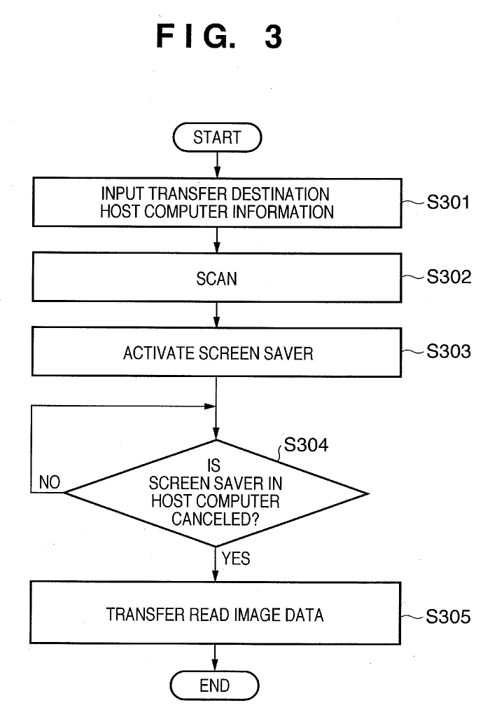

FIG. 3 is a flowchart illustrating processing in an MFP 111 according to the first exemplary embodiment of the present invention. A ROM 203 stores a program which execute this processing. The program is executed under the control of a CPU 202. Assume that in this embodiment, the user sets a password for a screen saver in advance in a host computer 101 as the transfer destination of read image data before the execution of this processing.

When a plurality of host computers connect to a network as shown in FIG. 2, the operator inputs information for designating a host computer as the transfer destination of image data read by a scanner 207 in step S301. The operator inputs the information for uniquely determining a host computer as a transfer designation by inputting or selecting the computer name of a computer as a transfer destination, a transfer destination address, or the like using an operation panel 205. When the operator designates a transfer destination in this manner, the process advances to step S302 to read an original by driving the scanner 207 in response to an instruction to start this reading operation after waiting for the input of an instruction to start reading the original from the operation panel 205. Upon completion of this original reading operation, the process advances to step S303 to activate the screen saver in the host computer designated as a transfer destination (e.g., the host computer 101) and lock the host computer 101.

In order to activate this screen saver, a program for activating the screen saver is prepared in the host computer 101, and the MFP 111 transmits a command for executing the program to the host computer 101 through an external I/F 208. This is an example of the method of activating the screen saver in the host computer 101. The process then advances to step S304 to wait until the host computer 101 is unlocked to safely transfer image data read by the MFP 111 to the host computer 101. That is, the process waits until the screen saver is cancelled. Upon determining that the screen saver in the host computer 101 is canceled, i.e., user entered password to unlock screen saver (YES in step S304), the process advances from step S304 to step S305 to transfer the image data read in step S302 to the host computer 101.

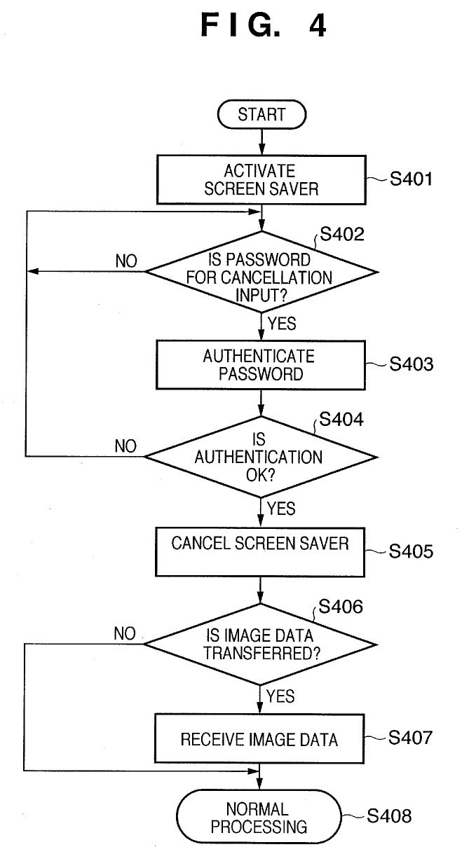

FIG. 4 is a flowchart illustrating processing in the host computer 101 according to the first and third embodiments of the present invention. An external storage device 106 stores a program for executing this processing. This program is loaded into a RAM 104 to be executed at the time of execution.

The process starts processing shown in FIG. 4 when the screen saver is activated from the MFP 111 in step S303 in FIG. 3. First of all, in step S401, the process activates the screen saver in accordance with an instruction from the MFP 111. This locks the host computer 101, and keeps the execution of the processing halted unless the screen saver is canceled. In step S402, the process waits until the operator inputs a password for the cancellation of the screen saver. When the operator inputs the password (YES in step S402), the process advances to step S403 to authenticate the input password. In this manner, the process authenticates whether the operation on the host computer 101 is the operation performed by the operator himself/herself. In step S404, the process determines whether a preset password matches the password input in step S402. If the password is authenticated (YES in step S404), the process advances to step S405 to cancel the screen saver and unlock the host computer 101. At this point, the host computer 101 notifies the MFP 111 that the screen saver has been cancelled. This allows the operator to perform operations on the host computer 101. In step S406, the process waits until the MFP 111 transfers the image data which it has read in step S305 in FIG. 3 to the host computer 101. When the image data is transferred, the host computer 101 receives the data and stores it in the external storage device 106 in step S407. The process then advances to normal processing in step S408. This allows the operator of the host computer 101 to acquire the image data read by the MFP 111. If the process determines in step S404 that the preset password does not match the password input in step S402 (NO in step S404), the process returns to step S402 to wait for the input of authentication information by the operator. If the process determines in step S406 that the host computer 101 does not receive the image data (NO in step S406), the process advances to step S408 to start normal processing.

As described above, before transferring read image data, the first embodiment sets the host computer at the transfer destination in the screen saver mode, and transfers the image data to the host computer after the cancellation of the screen saver mode. This makes it possible to reliably transfer image data required by the operator to the host computer while the operator is near the computer.

In addition, the embodiment is configured to cancel the screen saver mode only when the operator inputs the password for cancellation. This makes it impossible for any person other than the operator who has requested the image data, i.e., knows the password, to cancel the screen saver. This makes it possible to reliably transmit the required image data while the operator is operating the computer.

### Second Embodiment

The second exemplary embodiment of the present invention exemplifies a case wherein a host computer 101 is in a multi-user environment, i.e., a plurality of users can simultaneously log in to the host computer. Since the arrangements of a system, host computer, and MFP according to the second embodiment are the same as those of the first embodiment, a description thereof will not be repeated. The MFP has in advance information concerning a host computer to which it can connect, the name of a user, and information for user authentication.

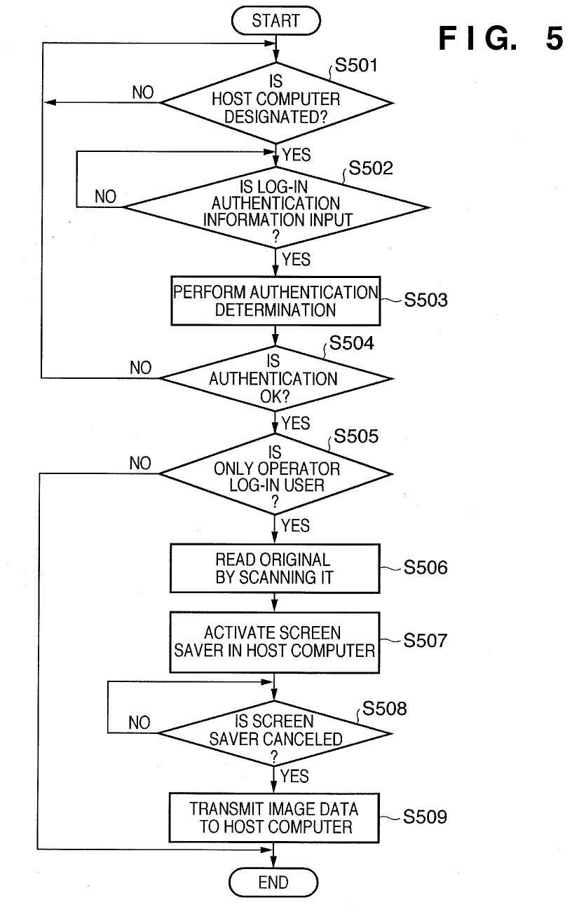

FIG. 5 is a flowchart illustrating processing in an MFP 111 according to the second embodiment of the present invention. A ROM 203 stores the contents of the flowchart shown in FIG. 5 as a control program. A CPU 202 executes this program.

First of all, in step S501, the process waits for the input of information which designates the host computer 101 as a transfer destination to which the image data read by a scanner 207 is to be transferred. The operator inputs information for uniquely determining this host computer as the transfer destination by inputting or selecting the name of a transfer destination computer, a transfer destination address, or the like using an operation panel 205. Upon designating a transfer destination in this manner (YES in step S501), the process advances to step S502 to wait for the input of authentication information for authenticating a log-in user to the host computer 101 designated in step S501. The authentication information input at this point may be the log-in user name of the host computer, log-in password, or the like. When the operator inputs authentication information by using the operation panel 205 in this manner (YES in step S502), the process authenticates, in step S503, the authentication information input in step S502. Upon determining in step S504 that the authentication performed in step S503 succeeded (YES in step S504), the process advances to step S505. If the authentication failed (NO in step S504), the process returns to step S501 to perform the above processing from the designation processing of a host computer.

In a multi-user environment, a plurality of users can simultaneously log in to one host computer. For this purpose, in step S505, the process acquires a status such as user information from the transfer destination host computer (e.g., the host computer 101) designated in step S501. The process then determines whether only the operator himself/herself has logged in to the host computer 101. If it is determined that it is not only the operator himself/herself logged in to the host computer 101 (NO in step S505), the process ends. On the other hand, if it is determined that only the operator himself/herself has logged in to the host computer 101 (YES in step S505), the process advances from step S505 to step S506 to permit the operator to read an original by using the scanner 207. When the operator issues an instruction to start reading the original through the operation panel 205, the process executes reading of the original by using the scanner 207. When the original reading operation is complete in this manner, the process advances to step S507 to activate the screen saver in the host computer 101 and lock the host computer 101. For example, this screen saver is activated by a method of preparing a program for activating the screen saver in the host computer 101, and activating the screen saver by transmitting a command for executing the program from the MFP 111.

The process advances to step S508 to wait for the cancellation of the screen saver in the host computer 101. That is, the process waits until the host computer 101 is unlocked. Upon determining that the screen saver in the host computer 101 is cancelled (YES in step S508), the process advances to step S509 to transfer the image data read in step S506 to the host computer 101.

Since processing in the host computer 101 according to the second embodiment is the same as that in the host computer 101 according to the first embodiment (FIG. 4), a description thereof will not be repeated.

As described above, according to the second embodiment, when the operator designates a host computer as the transfer destination of image data, the log-in ID for the computer is authenticated. Only when this operator logs in to the computer, the transfer of the image data is permitted. In addition, as in the first embodiment, a host computer as a transfer destination is set in the screen saver mode before the transfer of image data, and the image data is transferred to the host computer after the cancellation of the screen saver. This makes it possible for the operator who has designated the host computer as the transfer destination to more reliably acquire the image data through the designated host computer.

### Third Embodiment

The third embodiment of the present invention will be described next.

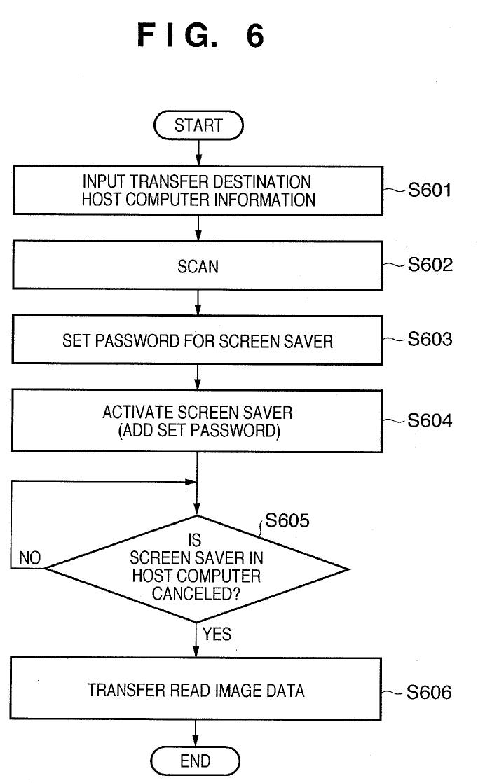

FIG. 6 is a flowchart illustrating processing in an MFP 111 according to the third embodiment of the present invention. A ROM 203 stores a program for executing this processing. This processing is executed under the control of a CPU 202.

In step S601, the process waits for the input of information for designating a host computer as a transfer destination to which read image data is to be transferred while a plurality of host computers connect to the MFP. The process uses the computer name of the host computer as the transfer destination, a transfer destination address, or the like as information which uniquely specifies the host computer. The operator then designates a desired host computer by inputting or selecting by using an operation panel 205. In step S602, when the operator issues an instruction to start reading an original through the operation panel 205, a scanner 207 reads the original. When this original reading operation is complete, the process waits until the operator inputs the password for the cancellation of the screen saver in the transfer destination host computer 101 by using the operation panel 205. When the operator inputs the password for the cancellation of the screen saver in this manner, the process advances to step S604 to activate the screen saver in the transfer destination screen saver (e.g., the host computer 101) and lock the host computer 101. For example, this screen saver is activated by a method of preparing a program for activating the screen saver in the host computer 101, and activating the screen saver by transmitting a command for executing the program from the MFP 111.

In this case, when transmitting this command, the third embodiment adds the password set in step S603 to the command and transmits it to the host computer 101. In step S605, the process waits until the host computer 101 is unlocked. That is, the process waits for the cancellation of the screen saver in the host computer. Upon determining that the screen saver in the host computer 101 is cancelled (YES in step S605), the process advances from step S605 to step S606 to transmit the image data read in step S602 to the host computer 101.

In this case, the processing in the host computer 101 can be executed in the same manner as the flowchart in FIG. 4 according to the first embodiment described above.

In step S401, the process activates the screen saver in accordance with the screen saver activation instruction in step S604 in FIG. 6. In step S402, the process waits for the input of the password for the cancellation of the screen saver from the MFP 111, which is transmitted together with the screen saver activation instruction. Upon receiving the password in step S402 (YES in step S402), the process authenticates, in step S403, whether the password matches the password for the cancellation of the screen saver. Upon authenticating that the input password is the password for the cancellation (YES in step S404), the process advances to step S405 to cancel the state of the screen saver and unlock the computer. In step S406, the process waits for the reception of image data from the MFP 111. When the MFP 111 transmits the image data, the process receives the image data and stores it in an external storage device 106 in step S407.

As described above, the third embodiment allows the operator to set the password for the screen saver in a transfer destination computer at the time of original reading by using the MFP. For this reason, even if the password for the screen saver is not set in the host computer in advance, the operator can cancel the screen saver by using the password.

The third embodiment has exemplified the case in which the operator can directly set the password for the screen saver in a host computer from the MFP 111. Alternatively, a password can be independently set and managed by making a dedicated utility or the like resident in a host computer and allow either the MFP or the host computer to set a password.

If the MFP is placed near a host computer, locking the host computer every time image data is transferred as in the above embodiment makes the operation cumbersome. For this reason, in exemplary embodiments, the operator is allowed to switch settings in the MFP to lock a host computer only when the screen saver mode time exceeds a set time interval.

Each of the first to third embodiments has exemplified a case in which upon determining that the screen saver is cancelled in a host computer, the MFP starts transferring read image data. However, each embodiment may take the form of making the MFP start sequentially transferring read image data after reading originals and allowing a host computer to acquire the transferred image data in the background while the screen saver is not cancelled.

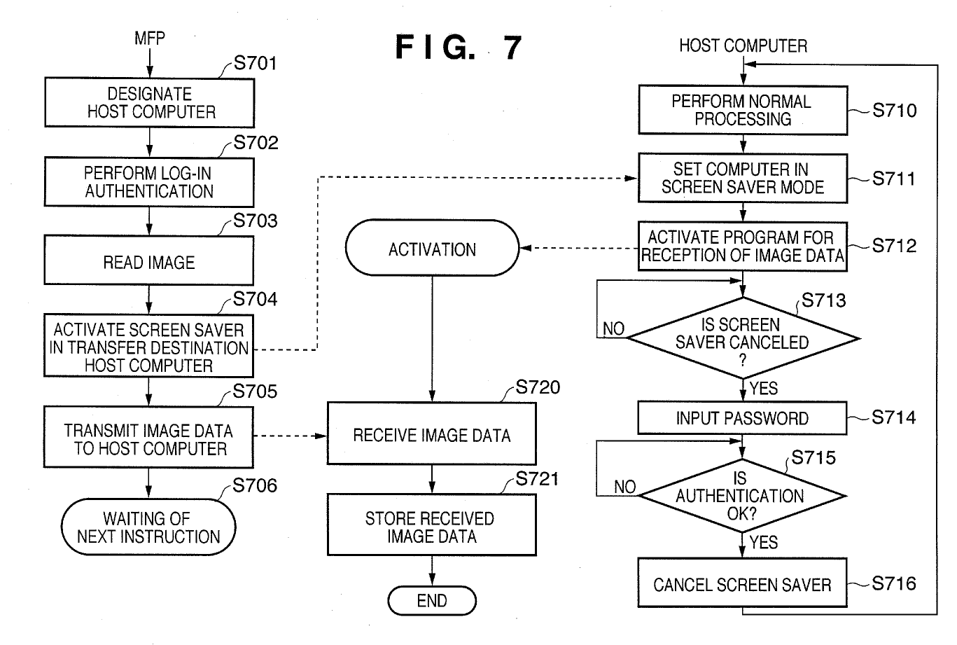

FIG. 7 is a sequence chart illustrating the exchange of information between the MFP 111 and a host computer in the system according to the above embodiments. In this case, the MFP 111 executes the processing in steps S701 to S706, and a host computer designated as the transfer destination of image data executes the processing in steps S710 to S716 and in steps S720 and S721.

First of all, in step S701, the operator designates a host computer as a destination to which image data read by the MFP 111 is to be transmitted. As described above, the operator designates a host computer by using its computer name, an address, or the like. In step S702, the operator designates a password for log-in authentication, as needed, as in the second embodiment. Note that step S702 can be omitted as in the first embodiment. In step S703, the scanner 207 reads an original image. In step S704, the process activates the screen saver in the host computer as the transfer destination. In step S705, the process transmits the read image data to the host computer.

First of all, upon receiving a screen saver activation command from the MFP 111 while executing normal processing (executing an application or the like) in step S710, the host computer shifts to the screen saver display mode (step S711). The process then displays a screen saver window and locks the computer. In step S712, the process activates an image data receiving program to start receiving image data in the background. With this operation, the MFP 111 executes reception processing of the image data transmitted in step S705 (step S720) and storage processing (step S721) in the background. During this period, the host computer waits for the screen saver to be canceled, i.e., entry of a password (step S713). When it is determined that the user wants to cancel the screen saver (YES in step), the operator inputs a password through the input unit 107 to cancel the screen saver mode (step S714). The process authenticates in step S715 whether the password is valid. Upon determining as a result of this authentication that the password is valid (YES in step S715), the process advances to step S716 to cancel the screen saver mode and return the computer from the lock state to the normal mode.

### Other Embodiments

Although the embodiments of the present invention have been described in detail above, the present invention can be applied to a system including a plurality of devices or a single apparatus. The software that controls the scanner function mounted in the MFP may be incorporated in the MFP body or on the host computer side.

The present invention can be implemented by directly or remotely supplying the programs (software) for implementing the functions of the embodiments described above to a system or apparatus and causing the computer of the system or apparatus to read out and execute the programs. In this case, the present invention may use any form other than programs as long as it has the functions of the programs.

The program code that is installed in the computer to allow the computer to implement the functions/processing of the present invention can also implement the above-described embodiments. In this case, each program may take any form, e.g., object code, a program executed by an interpreter, and script data supplied to an OS, as long as it has the function of the program.

As a storage medium for supplying the programs, various media can be used. The media include a floppy disk, hard disk, optical disk, magneto-optical disk (MO), CD-ROM, CD-R, CD-RW, magnetic tape, nonvolatile memory card, ROM, DVD (DVD-ROM or DVD-R), and the like.

In addition, methods of supplying the programs include the following. A client computer connects to a homepage on the Internet by using a browser to download the program from the homepage. In this case, each downloaded program may be the computer program of the present invention itself or a compressed file containing an automatic install function. Alternatively, the programs can be supplied by dividing the program code constituting each program of the present invention into a plurality of files, and downloading the respective files from different homepages. That is, the present invention can also incorporate a WWW server which allows a plurality of users to download program files for causing the computer to implement the functions/processing of the present invention.

In addition, the programs may be encrypted, and the encrypted data stored in a recording media such as a CD-ROM, that is distributed to users. In this case, the programs are installed in the computer so as to allow users who satisfy a predetermined condition to download key information for decryption from a homepage through the Internet and execute the encrypted programs using the key information.

The functions of the above-described embodiments can be implemented by a form other than the form of causing the computer to execute read programs. For example, the functions of the above embodiments can be implemented by causing the OS running on the computer or the like to perform part or all of actual processing based on the instructions of the programs.

The programs read out from the storage medium may be written in the memory of a function expansion board inserted into the computer or a function expansion unit connected to the computer. In this case, the functions of the above-described embodiments are implemented afterward by causing the CPU of the function expansion board or function expansion unit to perform part or all of actual processing based on the instructions of the programs.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-108029, filed Apr. 10, 2006, which is hereby incorporated by reference herein in its entirety.

What is claimed is:

1. An image processing apparatus which communicates with an external destination device through a network, comprising:
a transmitting unit configured to transmit a command for activating a screen saver in the external destination device through the network when the external destination device is specified for receiving image data; and
a control unit configured to control the transmitting unit to transmit the image data to the external destination device through the network after activating the screen saver in the external destination device.

2. The image processing apparatus according to claim 1, further comprising a cancellation determination unit configured to determine through the network whether the screen saver is cancelled in the external destination device, after the screen saver is activated in the external destination device,
wherein the control unit is configured to control the transmitting unit to transmit the image data to the external destination device when the cancellation determination unit determines that the screen saver is cancelled in the external destination device.

3. The image processing apparatus according to claim 1, wherein the transmitting unit is configured to transmit the command for activating the screen saver with a password for canceling the screen saver.

4. The image processing apparatus according to claim 1, further comprising a conversion unit configured to read an original image and convert the image into image data.

5. The image processing apparatus according to claim 1, further comprising an authentication unit configured to authenticate a log-in ID for logging into the external destination device,
wherein the transmitting unit is configured to transmit the command for activating the screen saver when authentication by the authentication unit succeeds.

6. The image processing apparatus according to claim 1, further comprising a user determination unit configured to determine whether there is another log-in user with respect to the destination device,
wherein the control unit is configured to control the transmitting unit to transmit the command for activating the screen saver when the user determination unit determines that there is no other log-in user.

7. An image processing system including an image processing apparatus and a destination computer device which connect to each other through a network, the image processing system comprising:
the image processing apparatus including:
a transmitting unit configured to transmit a command for activating a screen saver in the destination computer device through the network when a destination computer device is specified for receiving image data; and
a control unit configured to control the transmitting unit to transmit the image data to the destination computer device through the network after activating the screen saver in the destination computer device, and
the destination computer device including:
a display unit configured to display the screen saver in response to reception of the command for activating the screen saver; and
a receiving unit configured to receive the image data transmitted from the image processing apparatus after activation of the screen saver.

8. The image processing system according to claim 7, wherein
the image processing apparatus further includes a cancellation determination unit configured to cancel the screen saver in the destination computer device through the network after the screen saver is activated in the destination computer device,
the control unit is configured to control the transmitting unit to transmit image data to the destination computer device when the cancellation determination unit determines that the screen saver is cancelled in the destination computer device, and
the destination computer device further includes:
a cancellation unit configured to cancel the screen saver in response to an instruction to cancel the screen saver, and
a notification unit configured to notify the image processing apparatus that the screen saver is cancelled.

9. The image processing system according to claim 8, wherein the cancellation unit is configured to cancel the screen saver when a password matching a password for the screen saver is input.

10. The image processing system according to claim 7, wherein the image processing apparatus further includes a conversion unit configured to read an original image and convert the image into image data.

11. The image processing system according to claim 7, wherein the transmitting unit is configured to transmit the command for activating the screen saver with a password for canceling the screen saver.

12. The image processing system according to claim 7, wherein
the image processing apparatus further comprises an authentication unit configured to authenticate a log-in ID for logging in to the destination computer device, and
the control unit is configured to control the transmitting unit to transmit the command for activating the screen saver when authentication by the authentication unit succeeds.

13. The image processing system according to claim 7, wherein
the image processing apparatus further comprises a user determination unit configured to determine whether there is another log-in user with respect to the destination computer device, and
the control unit is configured to control the transmitting unit to transmit the command for activating the screen saver when the user determination unit determines that there is no other log-in user.

14. A method for an image processing apparatus which includes a communication unit configured to communicate with an external destination device through a network, the method comprising:
causing the communication unit to transmit a command for activating a screen saver in the external destination device through the network a command when the external destination device for receiving image data is specified; and
causing the communication unit to transmit the image data to the external destination device after the screen saver is activated in the external destination device.

15. The method according to claim 14, further comprising determining through the network whether the screen saver is canceled in the external destination device, after the screen saver is activated in the external destination device,
wherein the image data is transmitted to the external destination device when it is determined that the screen saver is cancelled in the external destination device.

16. The method according to claim 14, further comprising:
reading an original image; and
converting the image into image data.

17. The method according to claim 14, wherein the command for activating the screen saver is transmitted with a password for canceling the screen saver.

18. The method according to claim 14, further comprising authenticating a log-in ID for logging in to the external destination device,
wherein the command for activating the screen saver is transmitted when authentication succeeds.

19. The method according to claim 14, further comprising determining whether there is another log-in user with respect to the external destination device,
wherein the command for activating the screen saver is transmitted when it is determined that there is no other long-in user.
